(19) United States
(12) Patent Application Publication
(10) Pub. No.: US 2025/0237897 A1
(43) Pub. Date: Jul. 24, 2025

(54) ANTI-PEEP MODULE AND DISPLAY APPARATUS

(71) Applicant: Coretronic Corporation, Hsin-Chu (TW)

(72) Inventors: Yang-Ching Lin, Hsin-Chu (TW); Ping-Yen Chen, Hsin-Chu (TW); Chung-Yang Fang, Hsin-Chu (TW); Jing-Yu Wu, Hsin-Chu (TW)

(73) Assignee: Coretronic Corporation, Hsin-Chu (TW)

(21) Appl. No.: 19/032,451

(22) Filed: Jan. 21, 2025

Related U.S. Application Data
(60) Provisional application No. 63/623,342, filed on Jan. 22, 2024.

(30) Foreign Application Priority Data
Mar. 20, 2024 (CN) 202410318194.3

(51) Int. Cl. G02F 1/13; G02B 6/293; G02F 1/1337; G02F 1/1339

(52) U.S. Cl. CPC G02F 1/1323; G02B 6/29325; G02F 1/133757; G02F 1/13398

(57) ABSTRACT

An anti-peep module and a display apparatus including a first electrically-controlled viewing angle switching device and a first polarizer are provided. The first electrically-controlled viewing angle switching device includes a first alignment layer, a second alignment layer, a first liquid crystal layer, and first spacers. The first spacers have a first refractive index greater than a first ordinary ray refractive index and less than a first extraordinary ray refractive index of the first liquid crystal layer. When an absolute difference value between the first refractive index and the first extraordinary ray refractive index is less than 0.5, a first absorption axis of the first polarizer is perpendicular to a first alignment direction of the first alignment layer. When an absolute difference value between the first refractive index and the first ordinary ray refractive index is less than 0.5, the first absorption axis is parallel to the first alignment direction.

### CROSS-REFERENCE TO RELATED APPLICATION

This application claims the priority benefit of U.S. provisional application Ser. No. 63/623,342, filed on Jan. 22, 2024 and China application serial no. 202410318194.3, filed on Mar. 20, 2024. The entirety of the above-mentioned patent application is hereby incorporated by reference herein and made a part of this specification.

### BACKGROUND

### Technical Field

The disclosure relates to a display apparatus provided with an optical module, and in particular, to a display apparatus provided with an anti-peep module.

### Description of Related Art

In order to allow a display apparatus to be equipped with an anti-peep function, a technical solution is proposed in which an electrically-controllable viewing angle control device is placed above the display panel. Generally, this type of viewing angle control device is a liquid crystal device whose phase retardation can be electrically controlled to change, for example. During the manufacturing process of a liquid crystal device, a liquid crystal material is injected into the space between two transparent substrates to form a liquid crystal layer for light ray modulation. In order to control the thickness and uniformity of the liquid crystal layer, a plurality of spacers are required to be disposed in the space to control and maintain the height of the space.

However, as the pixel size of display apparatus decreases (pixel resolution increases), the impact generated by these spacers in the viewing angle control device on display quality becomes significant. For instance, if the display pixel size of the display panel is reduced to a size close to that of the spacers of the viewing angle control device, part of the light ray will generate optical path deflection at the interface between the spacers and the liquid crystal layer when passing through the interface. That is, the spacers create a lens-like effect, causing each sub-pixel to diffuse light to a different degree, so a user may experience a sense of glare (sparkle, the phenomenon of uneven brightness or color of pixels), and visual effect is thus affected.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an anti-peep module and a display apparatus.

The objectives and advantages of the disclosure may be further illustrated by the technical features broadly embodied and described as follows.

In order to achieve the above one, part of, or all of the objectives or other objectives, an embodiment of the disclosure provides an anti-peep module. The anti-peep module includes a first electrically-controlled viewing angle switching device, a first polarizer, and a second polarizer. The first electrically-controlled viewing angle switching device includes a first substrate, a second substrate, a first alignment layer, a second alignment layer, a first liquid crystal layer, and a plurality of first spacers. The first substrate and the second substrate are stacked on each other. The first alignment layer is disposed on the first substrate and has a first alignment direction. The second alignment layer is disposed on the second substrate and has a second alignment direction. An included angle between the first alignment direction and the second alignment direction is in a range of 165 degrees to 195 degrees. The first liquid crystal layer is disposed between the first alignment layer and the second alignment layer and has a plurality of first liquid crystal molecules. Each of the first liquid crystal molecules has a first optical axis, a first extraordinary ray refractive index, and a first ordinary ray refractive index. The first extraordinary ray refractive index is greater than the first ordinary ray refractive index. The plurality of first spacers are disposed between the first substrate and the second substrate and each has a first refractive index. The first refractive index is greater than the first ordinary ray refractive index and less than the first extraordinary ray refractive index. The first polarizer is disposed on one side of the first liquid crystal layer where the first alignment layer is disposed and has a first absorption axis. An axial direction of the first absorption axis is parallel to or perpendicular to the first alignment direction. The second polarizer is disposed on one side of the first liquid crystal layer where the second alignment layer is disposed and has a second absorption axis. An axial direction of the second absorption axis is parallel to or perpendicular to the second alignment direction. When an absolute difference value between the first refractive index and the first extraordinary ray refractive index is less than 0.05, the axial direction of the first absorption axis is perpendicular to the first alignment direction. When an absolute difference value between the first refractive index and the first ordinary ray refractive index is less than 0.05, the axial direction of the first absorption axis is parallel to the first alignment direction.

In order to achieve the above one, part of, or all of the objectives or other objectives, an embodiment of the disclosure provides a display apparatus. The display apparatus includes a self-luminous display panel and an anti-peep module. The anti-peep module is disposed on one side of a display surface of the self-luminous display panel and includes a first electrically-controlled viewing angle switching device, a first polarizer, and a second polarizer. The first electrically-controlled viewing angle switching device includes a first substrate, a second substrate, a first alignment layer, a second alignment layer, a first liquid crystal layer, and a plurality of first spacers. The first substrate and the second substrate are stacked on each other. The first alignment layer is disposed on the first substrate and has a first alignment direction. The second alignment layer is disposed on the second substrate and has a second alignment direction. An included angle between the first alignment direction and the second alignment direction is in a range of 165 degrees to 195 degrees. The first liquid crystal layer is disposed between the first alignment layer and the second alignment layer and has a plurality of first liquid crystal molecules. Each of the first liquid crystal molecules has a first optical axis, a first extraordinary ray refractive index, and a first ordinary ray refractive index. The first extraordinary ray refractive index is greater than the first ordinary ray refractive index. The plurality of first spacers are disposed between the first substrate and the second substrate and each has a first refractive index. The first refractive index is greater than the first ordinary ray refractive index and less than the first extraordinary ray refractive index. The first polarizer is disposed on one side of the first liquid crystal layer where the first alignment layer is disposed and has a first absorption axis. An axial direction of the first absorption axis is parallel to or perpendicular to the first alignment direction. The second polarizer is disposed on one side of the first liquid crystal layer where the second alignment layer is disposed and has a second absorption axis. An axial direction of the second absorption axis is parallel to or perpendicular to the second alignment direction. When an absolute difference value between the first refractive index and the first extraordinary ray refractive index is less than 0.05, the axial direction of the first absorption axis is perpendicular to the first alignment direction. When an absolute difference value between the first refractive index and the first ordinary ray refractive index is less than 0.05, the axial direction of the first absorption axis is perpendicular to the first alignment direction. When an absolute difference value between the first refractive index and the first ordinary ray refractive index is less than 0.05, the axial direction of the first absorption axis is parallel to the first alignment direction.

Although the disclosure has been disclosed above by the embodiments, they are not intended to limit the disclosure. It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

FIG. 1 is a schematic cross-sectional view of a display apparatus according to a first embodiment of the disclosure.

FIG. 2A is a schematic diagram showing arrangement relationships among alignment directions of alignment layers, axial directions of absorption axes of polarizers, and double-sided anti-peep axial directions in FIG. 1.

FIG. 2B is another variant implementation of FIG. 2A.

FIG. 3 is a cross-sectional schematic view of a display apparatus according to a second embodiment of the disclosure.

FIG. 4A and FIG. 4B are schematic diagrams showing arrangement relationships among alignment directions of alignment layers, axial directions of absorption axes of polarizers, and double-sided anti-peep axial directions in FIG. 3.

FIG. 4C is another variant implementation of FIG. 4B.

FIG. 5 is a schematic cross-sectional view of a display apparatus according to a third embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

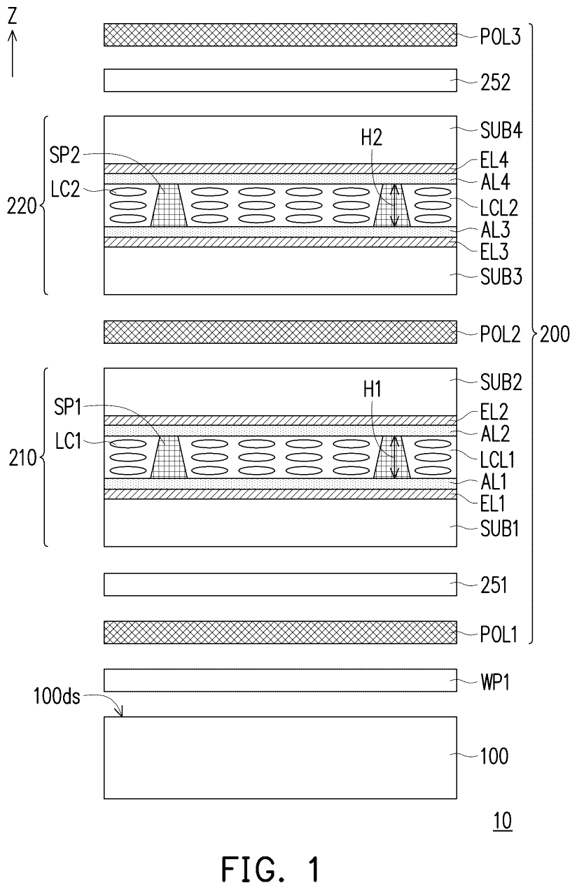

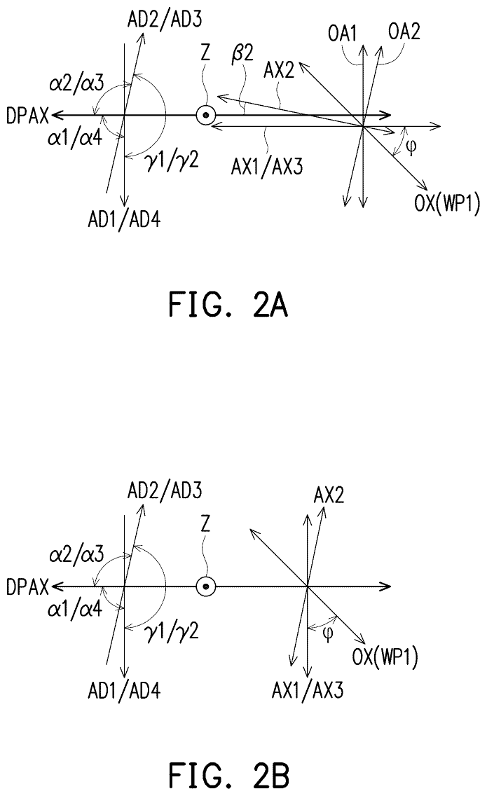

FIG. 1 is a schematic cross-sectional view of a display apparatus according to a first embodiment of the disclosure. FIG. 2A is a schematic diagram showing arrangement relationships among alignment directions of alignment layers, axial directions of absorption axes of polarizers, and double-sided anti-peep axial directions in FIG. 1. FIG. 2B is another variant implementation of FIG. 2A. It should be noted that an angular arrangement relationship shown in FIG. 2A and FIG. 2B is, for example, an angular arrangement relationship of a display apparatus 10 in a top-view (e.g., direction Z) direction.

With reference to FIG. 1, the display apparatus 10 includes a self-luminous display panel 100 and an anti-peep module 200. The anti-peep module 200 is disposed on one side of a display surface 100ds (e.g., a surface where a display light beam leaves the self-luminous display panel 100) of the self-luminous display panel 100 and includes a first electrically-controlled viewing angle switching device 210, a second electrically-controlled viewing angle switching device 220, a first polarizer POL1, a second polarizer POL2, and a third polarizer POL3. The first electrically-controlled viewing angle switching device 210 is disposed between the second electrically-controlled viewing angle switching device 220 and the self-luminous display panel 100. The first polarizer POL1 is disposed between the first electrically-controlled viewing angle switching device 210 and the self-luminous display panel 100. The second polarizer POL2 is disposed between the first electrically-controlled viewing angle switching device 210 and the second electrically-controlled viewing angle switching device 220. The third polarizer POL3 is disposed on one side of the second electrically-controlled viewing angle switching device 220 facing away from the first electrically-controlled viewing angle switching device 210 (i.e., the second electrically-controlled viewing angle switching device 220 is disposed between the third polarizer POL3 and the first electrically-controlled viewing angle switching device 210). It is particularly noted that the self-luminous display panel 100 and the first polarizer POL1 are combined, for example, in a non-full-bonding manner, such as an air bonding manner, and the other optical devices are combined in a full-bonding manner, for example.

More specifically, on the display surface 100ds of the self-luminous display panel 100 and in the direction Z, the first polarizer POL1, the first electrically-controlled viewing angle switching device 210, the second polarizer POL2, the second electrically-controlled viewing angle switching device 220, and the third polarizer POL3 are sequentially stacked. The direction Z is, for example, perpendicular to the display surface 100ds.

The self-luminous display panel 100 is, for example, an organic light emitting diode (OLED) display panel, a micro light emitting diode (micro-LED) display panel, or a mini light emitting diode (mini-LED) display panel, but the disclosure is not limited thereto.

The first electrically-controlled viewing angle switching device 210 includes a first substrate SUB1, a second substrate SUB2, a first liquid crystal layer LCL1, a first alignment layer AL1, and a second alignment layer AL2. The first alignment layer AL1 is disposed on the first substrate SUB1 and is located between the first liquid crystal layer LCL1 and the first polarizer POL1 (or located between the first liquid crystal layer LCL1 and the first substrate SUB1). The second alignment layer AL1 is disposed on the second substrate SUB2 and is located between the first liquid crystal layer LCL1 and the second polarizer POL2 (or located between the first liquid crystal layer LCL1 and the second substrate SUB2). The first liquid crystal layer LCL1 is disposed between the first alignment layer AL1 and the second alignment layer AL2.

The second electrically-controlled viewing angle switching device 220 includes a third substrate SUB3, a fourth substrate SUB4, a second liquid crystal layer LCL2, a third alignment layer AL3, and a fourth alignment layer AL4. The third alignment layer AL3 is disposed on the third substrate SUB3 and is located between the second liquid crystal layer LCL2 and the second polarizer POL2 (or located between the second liquid crystal layer LCL2 and the third substrate SUB3). The fourth alignment layer AL4 is disposed on the fourth substrate SUB4 and is located between the second liquid crystal layer LCL2 and the third polarizer POL3 (or located between the second liquid crystal layer LCL2 and the fourth substrate SUB4). The second liquid crystal layer LCL1 is disposed between the third alignment layer AL3 and the fourth alignment layer AL4.

A material of the substrate of the electrically-controlled viewing angle switching devices may include glass, triacetate (TAC), cyclo-olefin polymer (COP), polycarbonate (PC), polymethyl methacrylate (PMMA), polyimide (PI), other suitable high molecular polymers, or a plate material with a phase retardation (e.g., a stretched compensation film).

It is particularly noted that the two alignment layers of each of the electrically-controlled viewing angle switching devices are configured to determine the arrangement state of the liquid crystal layer in a natural state (e.g., without being affected by an electric field). In order to drive the liquid crystal layer, each of the electrically-controlled viewing angle switching devices may further include two electrode layers, which are arranged on opposite sides of the liquid crystal layer. When the two electrode layers are enabled to have a potential difference, a plurality of liquid crystal molecules in the liquid crystal layer may be deflected by the electric field formed between the two electrode layers. Each of the electrode layers is, for example, a light-transmitting electrode, and a material of the light-transmitting electrode may include metal oxides, such as indium tin oxide, indium zinc oxide, aluminum tin oxide, aluminum zinc oxide, other suitable oxides, or a stacked layer of at least two of the above, but the disclosure is not limited thereto.

For instance, in this embodiment, the first electrically-controlled viewing angle switching device 210 further includes a first electrode layer EL1 and a second electrode layer EL2 respectively disposed on the first substrate SUB1 and the second substrate SUB2 and are configured to drive a plurality of first liquid crystal molecules LC1 of the first liquid crystal layer LCL1. Similarly, the second electrically-controlled viewing angle switching device 220 further includes a third electrode layer EL3 and a fourth electrode layer EL4 respectively disposed on the third substrate SUB3 and the fourth substrate SUB4 and are configured to drive a plurality of second liquid crystal molecules LC2 of the second liquid crystal layer LCL2.

By adjusting a voltage applied between the first electrode layer EL1 and the second electrode layer EL2 of the first electrically-controlled viewing angle switching device 210 and a voltage applied between the third electrode layer EL3 and the fourth electrode layer EL4 of the second electrically-controlled viewing angle switching device 220, the display apparatus 10 can be switched between a sharing mode and an anti-peep mode. For instance, when a first voltage is applied between the first electrode layer EL1 and the second electrode layer EL2, or/and a third voltage is applied between the third electrode layer EL3 and the fourth electrode layer EL4, the display apparatus 10 operates in the anti-peep mode. When a second voltage is applied between the first electrode layer EL1 and the second electrode layer EL2, and a fourth voltage is applied between the third electrode layer EL3 and the fourth electrode layer EL4, the display apparatus 10 operates in the sharing mode.

In the disclosure, the liquid crystal layers of the electrically-controlled viewing angle switching devices may be driven in either a twisted-nematic (TN) mode or an electrically-controlled birefringence (ECB) mode. For instance, in this embodiment, the first electrically-controlled viewing angle switching device 210 and the second electrically-controlled viewing angle switching device 220 are both driven in the ECB mode, and the first liquid crystal layer LCL1 and the second liquid crystal layer LCL2 are, for example, positive liquid crystals.

With reference to FIG. 1 and FIG. 2A together, in this embodiment, each of the first electrically-controlled viewing angle switching device 210 and the second electrically-controlled viewing angle switching device 220 has a double-sided anti-peep axial direction DPAX that is perpendicular to the direction Z. That is, the two electrically-controlled viewing angle switching devices can enable the display apparatus 10 to exhibit an anti-peep effect within a viewing angle range on both sides in the double-sided anti-peep axial direction DPAX. To be specific, the double-sided anti-peep axial direction DPAX includes a 90-degree direction and a −90-degree direction in the same dimension (for example, in a horizontal dimension in FIG. 2A, the viewing angle ranges from 90 degrees to −90 degrees, where the viewing angle of 0 degrees is a front viewing direction (e.g., direction Z)) and opposite to each other. Herein, the 90-degree direction is, for example, a direction toward the right side in FIG. 2A, and the −90-degree direction is, for example, a direction toward the left side in FIG. 2A.

In this embodiment, an included angle α1 between a first alignment direction AD1 of the first alignment layer AL1 and the −90-degree direction of the double-sided anti-peep axial direction DPAX may be 90 degrees. An included angle α2 between a second alignment direction AD2 of the second alignment layer AL2 and the −90-degree direction of the double-sided anti-peep axial direction DPAX may be 95 degrees. That is, an included angle γ1 between the first alignment direction AD1 and the second alignment direction AD2 is 175 degrees, but it is not limited thereto. In other embodiments, the included angle between the first alignment direction AD1 and the second alignment direction AD2 is in a range of 165 degrees to 195 degrees.

Similarly, an included angle α3 between a third alignment direction AD3 of the third alignment layer AL3 and the −90-degree direction of the double-sided anti-peep axial direction DPAX may be 95 degrees. An included angle α4 between a fourth alignment direction AD4 of the fourth alignment layer AL4 and the −90-degree direction of the double-sided anti-peep axial direction DPAX may be 90 degrees. That is, an included angle γ2 between the third alignment direction AD3 and the fourth alignment direction AD4 is 175 degrees, but it is not limited thereto. In other embodiments, the included angle between the third alignment direction AD3 and the fourth alignment direction AD4 is in the range of 165 degrees to 195 degrees.

To be more specifically, in this embodiment, the first alignment direction AD1 and the fourth alignment direction AD4 are parallel to each other and perpendicular to the double-sided anti-peep axial direction DPAX, and the second alignment direction AD2 is parallel to the third alignment direction AD3.

In this embodiment, an axial direction of a first absorption axis AX1 of the first polarizer POL1 may be perpendicular to the first alignment direction AD1, and an axial direction of a third absorption axis AX3 of the third polarizer POL3 may be perpendicular to the fourth alignment direction AD4. That is, the axial directions of the first absorption axis AX1 and the third absorption axis AX3 are parallel to each other. An included angle β2 between the −90-degree direction of the double-sided anti-peep axial direction DPAX and the second absorption axis AX2 of the second polarizer POL2 is, for example, 5 degrees, but it is not limited thereto.

Further, each of the plurality of first liquid crystal molecules LC1 of the first liquid crystal layer LCL1 has a first optical axis OA1, a first extraordinary ray refractive index in a direction parallel to the first optical axis OA1, and a first ordinary ray refractive index in a direction perpendicular to the first optical axis OA1. Each of the plurality of second liquid crystal molecules LC2 of the second liquid crystal layer LCL2 has a second optical axis OA2, a second extraordinary ray refractive index in a direction parallel to the second optical axis OA2, and a second ordinary ray refractive index in a direction perpendicular to the second optical axis OA2.

It is particularly noted that the first optical axis OA1 shown in FIG. 2A is the first optical axis OA1 (e.g., a molecular long axis of the first liquid crystal molecule LC1) of the first liquid crystal molecule LC1 in the first liquid crystal layer LCL1 that is closer to the first alignment layer AL1 (or the first polarizer POL1). The second optical axis OA2 shown in FIG. 2A is the second optical axis OA2 of the second liquid crystal molecule LC2 in the second liquid crystal layer LCL2 that is closer to the third alignment layer AL3 (or the second polarizer POL2).

In order to control a film thickness and uniformity of each of the first liquid crystal layer LCL1 and the second liquid crystal layer LCL2, the first electrically-controlled viewing angle switching device 210 further includes a plurality of first spacers SP1 between the first substrate SUB1 and the second substrate SUB2, and the second electrically-controlled viewing angle switching device 220 further includes a plurality of second spacers SP2 between the third substrate SUB3 and the fourth substrate SUB4. The first spacers SP1 and the second spacers SP2 have a first refractive index and a second refractive index, respectively. The first refractive index is greater than the first ordinary ray refractive index and less than the first extraordinary ray refractive index, and the second refractive index is greater than the second ordinary ray refractive index and less than the second extraordinary ray refractive index. Preferably, a width of each of the first spacers SP1 and the second spacers SP2 in any direction perpendicular to the direction Z may be less than 15 μm.

For instance, in this embodiment, an absolute difference value between the first refractive index and the first extraordinary ray refractive index is less than 0.05, and an absolute difference value between the second refractive index and the second extraordinary ray refractive index is less than 0.05. Therefore, by arranging the axial direction of the first absorption axis AX1 of the first polarizer POL1 to be perpendicular to the first alignment direction AD1, the refractive index difference between the first spacers SP1 and the first liquid crystal layer LCL1 in a polarization direction of a light ray (not shown) passing through the first polarizer POL1 can be less than 0.05, so that the light ray may not generate obvious optical path deflection when passing through an interface between the first spacers SP1 and the first liquid crystal layer LCL1. Similarly, by arranging the second absorption axis AX2 of the second polarizer POL2 to be perpendicular to the third alignment direction AD3, the refractive index difference between the second spacers SP2 and the second liquid crystal layer LCL2 in the polarization direction of the light ray (not shown) passing through the second polarizer POL2 can be less than 0.05, so that the light ray may not generate obvious optical path deflection when passing through an interface between the second spacers SP2 and the second liquid crystal layer LCL2. Accordingly, a user is prevented from noticing the pixel color unevenness caused by the optical path deflection at the interface between the spacers and the liquid crystal layer when the user views the display apparatus 10, or the user is prevented from observing flickering when the user changes his/her viewing angles, so that a visual effect of a display image is improved.

Nevertheless, the disclosure is not limited thereto. In another variant embodiment, the absolute difference value between the first refractive index of the first spacers SP1 and the first ordinary ray refractive index may be less than 0.05, and the absolute difference value between the second refractive index of the second spacers SP2 and the second ordinary ray refractive index may be less than 0.05. Therefore, in order to prevent the user from noticing the problem of pixel color unevenness when viewing a displayed image, the axial directions of the first absorption axis AX1 of the first polarizer POL1 and the third absorption axis AX3 of the third polarizer POL3 may be arranged parallel to the first alignment direction AD1, and the second absorption axis AX2 of the second polarizer POL2 may be arranged parallel to the third alignment direction AD3 (as shown in FIG. 2B).

It is particularly noted that in the abovementioned variant embodiment, the second voltage applied to the first electrode layer EL1 and the second electrode layer EL2 of the first electrically-controlled viewing angle switching device 210 in the sharing mode may be higher than the first voltage applied in the anti-peep mode, and the fourth voltage applied to the third electrode layer EL3 and the fourth electrode layer EL4 of the second electrically-controlled viewing angle switching device 220 in the sharing mode may be higher than the third voltage applied in the anti-peep mode. The first liquid crystal layer LCL1 and the second liquid crystal layer LCL2 are both positive liquid crystals, for example. When the display apparatus 10 operates in the sharing mode, the axial directions of the molecular long axes of the first liquid crystal molecules LC1 and the second liquid crystal molecules LC2 tend to be arranged in the Z direction, for example. Therefore, the absolute difference values in the refractive indexes of the spacers and the liquid crystal layers in directions perpendicular to the Z direction may not differ too much. In this way, the pixel color unevenness caused by the optical path deflection at the interface between the spacers and the liquid crystal layers can be further mitigated.

It is worth mentioning that in order to further mitigate the aforementioned pixel color unevenness problem caused by the spacers, preferably, the absolute difference value between the ordinary ray refractive index and the extraordinary ray refractive index of each of the first liquid crystal layer LCL1 and the second liquid crystal layer LCL2 may be less than 0.12, and heights (e.g., height H1 and height H2 shown in FIG. 1) of the spacers in the stacking direction (e.g., direction Z) of the two adjacent substrates may be greater than 5 μm and less than 10 μm, but the disclosure is not limited thereto.

Further, in this embodiment, the anti-peep module 200 may further selectively include a compensation film 251 and a compensation film 252. The compensation film 251 is disposed between the first polarizer POL1 and the first liquid crystal layer LCL1, and the compensation film 252 is disposed between the third polarizer POL3 and the second liquid crystal layer LCL2. An out-of-plane phase retardation (Rth) of each of the compensation film 251 and the compensation film 252 may be in a range of 100 nm to 500 nm. In this embodiment, the out-of-plane phase retardation of each of the compensation film 251 and the compensation film 252 is, for example, 280 nm. On the other hand, a quarter-wave plate WP1 may be further disposed between the first polarizer POL1 of the anti-peep module 200 and the self-luminous display panel 100. An included angle φ between an optical axis OX of the quarter-wave plate WP1 and the first absorption axis AX1 of the first polarizer POL1 is 45 degrees.

It is worth mentioning that in this embodiment, a reflective polarizing layer (not shown) or a metal wire grid polarizing layer may be further disposed between the second polarizer POL2 and the third substrate SUB3, but the disclosure is not limited thereto. Accordingly, when the display apparatus 10 operates in the anti-peep mode, ambient light may be reflected by the reflective polarizing layer within an anti-peep viewing angle range, so that display contrast of the display image within the anti-peep viewing angle range is reduced, and the anti-peep effect may be further improved.

Some other embodiments are listed below to illustrate the disclosure in detail. Identical reference numerals are used to represent identical components, and descriptions of identical technical contents are omitted. For the omitted parts, description thereof may be found with reference to the foregoing embodiments, which is described in detail below.

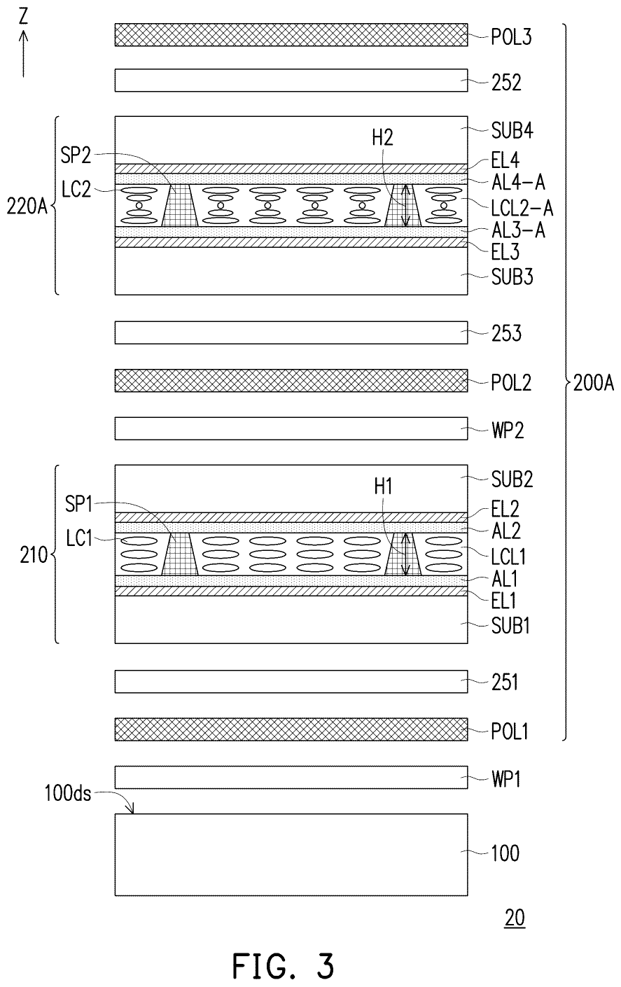

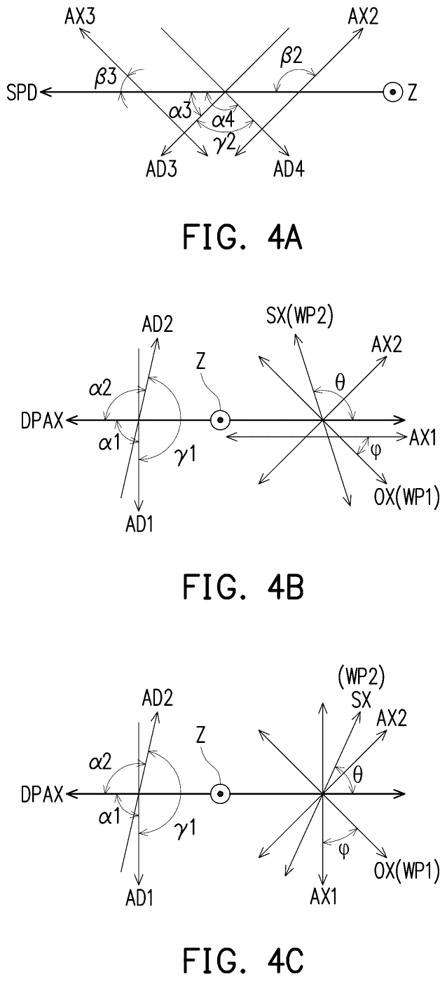

FIG. 3 is a cross-sectional schematic view of a display apparatus according to a second embodiment of the disclosure. FIG. 4A and FIG. 4B are schematic diagrams showing arrangement relationships among alignment directions of alignment layers, axial directions of absorption axes of polarizers, and double-sided anti-peep axial directions in FIG. 3. FIG. 4C is another variant implementation of FIG. 4B. It should be noted that an angular arrangement relationship shown in FIG. 4A, FIG. 4B, and FIG. 4C is, for example, an angular arrangement relationship of a display apparatus 20 in a top-view (e.g., direction Z) direction.

With reference to FIG. 3, FIG. 4A, and FIG. 4B, the difference between the display apparatus 20 of this embodiment and the display apparatus 10 of FIG. 1 is that the second electrically-controlled viewing angle switching device is driven by a different mode. In this embodiment, a second liquid crystal layer LCL2-A of a second electrically-controlled viewing angle switching device 220A of an anti-peep module 200A is driven in a twisted-nematic (TN) mode, for example. That is, the third alignment direction AD3 of a third alignment layer AL3-A of the second electrically-controlled viewing angle switching device 220A is perpendicular to the fourth alignment direction AD4 of a fourth alignment layer AL4-A. That is, an included angle γ2 between the third alignment direction AD3 and the fourth alignment direction AD4 is 90 degrees.

It is particularly noteworthy that the second electrically-controlled viewing angle switching device 220A has a single-sided anti-peep direction SPD perpendicular to the direction Z. The single-sided anti-peep direction SPD is parallel to the −90-degree direction of the double-sided anti-peep axial direction DPAX of the first electrically-controlled viewing angle switching device 210, but the disclosure is not limited thereto. To be more specific, the first electrically-controlled viewing angle switching device 210 may enable the display apparatus 20 to exhibit an anti-peep effect within the viewing angle range on both sides in the double-sided anti-peep axial direction DPAX, and the second electrically-controlled viewing angle switching device 220A may enable the display apparatus 20 to exhibit an anti-peep effect within the viewing angle range on single side in the single-sided anti-peep direction SPD.

Included angles between the third alignment direction AD3 of the third alignment layer AL3-A and the fourth alignment direction AD4 of the fourth alignment layer AL4-A and the single-sided anti-peep direction SPD are in a range of 40 degrees to 50 degrees or 130 degrees to 140 degrees. For instance, in this embodiment, an included angle α3 between the third alignment direction AD3 and the single-sided anti-peep direction SPD may be 45 degrees, and an included angle α4 between the fourth alignment direction AD4 and the single-sided anti-peep direction SPD may be 135 degrees.

On the other hand, the axial direction of the second absorption axis AX2 of the second polarizer POL2 may be parallel to the third alignment direction AD3 of the third alignment layer AL3-A, and the axial direction of the third absorption axis AX3 of the third polarizer POL3 may be parallel to the fourth alignment direction AD4 of the fourth alignment layer AL4-A, but the disclosure is not limited thereto. In other embodiments, the axial direction of the second absorption axis AX2 may be perpendicular to the third alignment direction AD3, and the axial direction of the third absorption axis AX3 may be perpendicular to the fourth alignment direction AD4.

In this embodiment, the second absorption axis AX2 of the second polarizer POL2 may be perpendicular to the third absorption axis AX3 of the third polarizer POL3. Included angles between the second absorption axis AX2 and the third absorption axis AX3 and the single-sided anti-peep direction SPD are in a range of 40 degrees to 50 degrees or 130 degrees to 140 degrees. For instance, in this embodiment, an included angle β2 between the second absorption axis AX2 and the single-sided anti-peep direction SPD may be 135 degrees, and an included angle β3 between the third absorption axis AX3 and the single-sided anti-peep direction SPD may be 45degrees.

In this embodiment, since the arrangement relationship between the first electrically-controlled viewing angle switching device 210 and the first polarizer POL1 is similar to that between the first electrically-controlled viewing angle switching device 210 and the first polarizer POL1 in FIG. 1, detailed description may be found with reference to the relevant paragraphs of the aforementioned embodiments and thus is not repeated herein.

In this embodiment, the anti-peep module 200A may further selectively include a half-wave plate WP2 disposed between the first electrically-controlled viewing angle switching device 210 and the second electrically-controlled viewing angle switching device 220A, and the half-wave plate WP2 has a slow axis SX. It is particularly noteworthy that when the absolute difference value between the first refractive index of the first spacers SP1 and the first extraordinary ray refractive index of the first liquid crystal molecules LC1 is less than 0.05, an included angle θ between the slow axis SX of the half-wave plate WP2 and the double-sided anti-peep axial direction DPAX is 110 degrees (as shown in FIG. 4B). When the absolute difference value between the first refractive index of the first spacers SP1 and the first ordinary ray refractive index of the first liquid crystal molecules LC1 is less than 0.05, the included angle θ between the slow axis SX of the half-wave plate WP2 and the double-sided anti-peep axial direction DPAX is 65 degrees (as shown in FIG. 4C).

In addition to arranging the axial direction of the first absorption axis AX1 of the first polarizer POL1 to be perpendicular to the first alignment direction AD1, the slow axis SX of the half-wave plate WP2 is arranged in the above manner. In this way, when the user views the display apparatus 20, the user is further prevented from noticing the pixel color unevenness caused by the optical path deflection at the interface between the first spacers SP1 and first liquid crystal layer LCL1, so that the visual effect of the display image is improved.

In this embodiment, in order to further mitigate the aforementioned pixel color unevenness problem caused by the spacers, preferably, the absolute difference value between the ordinary ray refractive index and the extraordinary ray refractive index of the second liquid crystal layer LCL2-A may be less than 0.12 (in this embodiment, the absolute difference value between the ordinary ray refractive index and the extraordinary ray refractive index of the first liquid crystal layer LCL1 may not be limited, for example, may be greater than 0.12). Further, the heights (e.g., height H2 shown in FIG. 3) of the spacers in the stacking direction (e.g., direction Z) of the two adjacent substrates may be greater than 5 μm and less than 10 μm, but the disclosure is not limited thereto.

In this embodiment, the anti-peep module 200A may further include a compensation film 253 disposed between the second polarizer POL2 and the second liquid crystal layer LCL2. It is particularly noted that in this embodiment, since the second liquid crystal layer LCL2-A of the second electrically-controlled viewing angle switching device 220A is driven in the TN mode, the out-of-plane phase retardation (Rth) of each of the compensation film 252 and the compensation film 253 is within a range of −50 nm to −300 nm. In this embodiment, a sum of the out-of-plane phase retardation of the compensation film 252 and the out-of-plane phase retardation of the compensation film 253 is, for example,−200 nm.

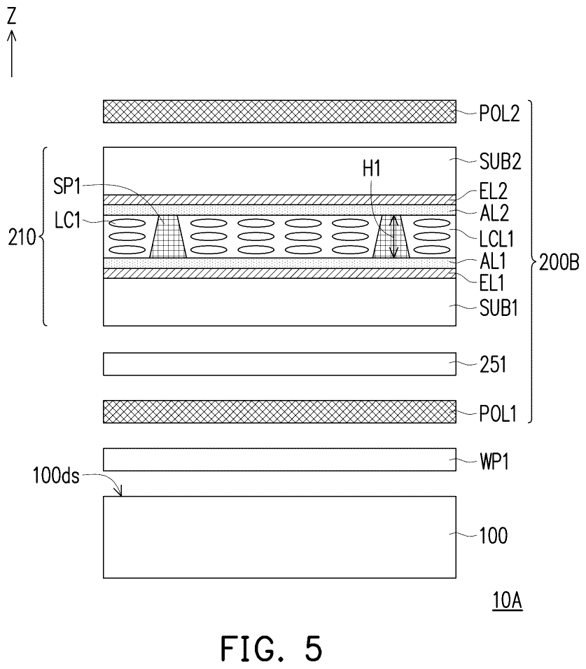

FIG. 5 is a schematic cross-sectional view of a display apparatus according to a third embodiment of the disclosure. With reference to FIG. 5, different from the display apparatus 10 in FIG. 1, a display apparatus 10A of this embodiment is only provided with the first electrically-controlled viewing angle switching device 210. In other words, in the display apparatus 10A, the second electrically-controlled viewing angle switching device 220, the compensation film 252, and the third polarizer POL3 of FIG. 1 are omitted.

In this embodiment, since the first electrically-controlled viewing angle switching device 210 is similar to the first electrically-controlled viewing angle switching device 210 in FIG. 1, detailed description may be found with reference to the relevant paragraphs of the aforementioned embodiments and thus is not repeated herein.

In view of the foregoing, in the anti-peep module and the display apparatus provided in an embodiment of the disclosure, a plurality of first spacers define a containing space for filling the first liquid crystal layer between the first substrate and the second substrate of the first electrically-controlled viewing angle switching device. The first refractive index of the first spacers is within the range between the first ordinary ray refractive index and the first extraordinary ray refractive index of the first liquid crystal layer. The arrangement relationship between the first absorption axis of the first polarizer and the first alignment direction of the adjacent first alignment layer depends on the difference between the first refractive index of the first spacers and the first ordinary ray refractive index or the first extraordinary ray refractive index. Therefore, the optical path deflection angle when the light ray passes through the interface between the first spacers and the first liquid crystal layer may be effectively reduced. Accordingly, the anti-peep module and the display apparatus according to an embodiment of the disclosure have at least one of the following advantages: the user is prevented from noticing the phenomenon of pixel color unevenness when viewing the display apparatus, and the visual effect of the display image is thereby improved.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An anti-peep module, comprising a first electrically-controlled viewing angle switching device, a first polarizer, and a second polarizer, wherein
the first electrically-controlled viewing angle switching device comprises a first substrate, a second substrate, a first alignment layer, a second alignment layer, a first liquid crystal layer, and a plurality of first spacers, wherein
the first substrate and the second substrate are stacked on each other,
the first alignment layer is disposed on the first substrate and has a first alignment direction,
the second alignment layer is disposed on the second substrate and has a second alignment direction, wherein an included angle between the first alignment direction and the second alignment direction is in a range of 165 degrees to 195 degrees,
the first liquid crystal layer is disposed between the first alignment layer and the second alignment layer and has a plurality of first liquid crystal molecules, each of the plurality of first liquid crystal molecules has a first optical axis, a first extraordinary ray refractive index, and a first ordinary ray refractive index, and the first extraordinary ray refractive index is greater than the first ordinary ray refractive index, and
the plurality of first spacers are disposed between the first substrate and the second substrate and each has a first refractive index, and the first refractive index is greater than the first ordinary ray refractive index and less than the first extraordinary ray refractive index,
the first polarizer is disposed on one side of the first liquid crystal layer where the first alignment layer is disposed and has a first absorption axis, and an axial direction of the first absorption axis is parallel to or perpendicular to the first alignment direction, and
the second polarizer is disposed on one side of the first liquid crystal layer where the second alignment layer is disposed and has a second absorption axis, and an axial direction of the second absorption axis is parallel to or perpendicular to the second alignment direction,
wherein when an absolute difference value between the first refractive index and the first extraordinary ray refractive index is less than 0.05, the axial direction of the first absorption axis is perpendicular to the first alignment direction, and when an absolute difference value between the first refractive index and the first ordinary ray refractive index is less than 0.05, the axial direction of the first absorption axis is parallel to the first alignment direction.

2. The anti-peep module according to claim 1, further comprising a second electrically-controlled viewing angle switching device and a third polarizer, wherein
the second electrically-controlled viewing angle switching device is disposed on one side of the second polarizer facing away from the first electrically-controlled viewing angle switching device, and the second electrically-controlled viewing angle switching device comprises a third substrate, a fourth substrate, a third alignment layer, a fourth alignment layer, a second liquid crystal layer, and a plurality of second spacers, wherein
the third substrate and the fourth substrate are stacked on each other,
the third alignment layer is disposed on the third substrate and has a third alignment direction,
the fourth alignment layer is disposed on the fourth substrate and has a fourth alignment direction, wherein an included angle between the third alignment direction and the fourth alignment direction is in a range of 165 degrees to 195 degrees,
the second liquid crystal layer is disposed between the third alignment layer and the fourth alignment layer and has a plurality of second liquid crystal molecules, each of the plurality of second liquid crystal molecules has a second optical axis, a second extraordinary ray refractive index, and a second ordinary ray refractive index, and the second extraordinary ray refractive index is greater than the second ordinary ray refractive index, and
the plurality of second spacers are disposed between the third substrate and the fourth substrate and each has a second refractive index, and the second refractive index is greater than the second ordinary ray refractive index and less than the second extraordinary ray refractive index, and
the third polarizer is disposed on one side of the second electrically-controlled viewing angle switching device facing away from the first electrically-controlled viewing angle switching device and has a third absorption axis, and the third absorption axis is parallel to or perpendicular to the fourth alignment direction,
wherein when an absolute difference value between the second refractive index and the second extraordinary ray refractive index is less than 0.05, the axial direction of the second absorption axis is perpendicular to the third alignment direction, and when an absolute difference value between the second refractive index and the second ordinary ray refractive index is less than 0.05, the axial direction of the second absorption axis is parallel to the third alignment direction.

3. The anti-peep module according to claim 2, wherein each of the first electrically-controlled viewing angle switching device and the second electrically-controlled viewing angle switching device has a double-sided anti-peep axial direction, the first alignment direction and the fourth alignment direction are perpendicular to the double-sided anti-peep axial direction, and the second alignment direction is parallel to the third alignment direction.

4. The anti-peep module according to claim 2, further comprising a first compensation film and a second compensation film, wherein
the first compensation film is disposed between the first polarizer and the first liquid crystal layer, and
the second compensation film is disposed between the third polarizer and the second liquid crystal layer, wherein an out-of-plane phase retardation of each of the first compensation film and the second compensation film is in a range of 100 nm to 500 nm.

5. The anti-peep module according to claim 1, further comprising a second electrically- controlled viewing angle switching device and a third polarizer, wherein
the second electrically-controlled viewing angle switching device is disposed on one side of the second polarizer facing away from the first electrically-controlled viewing angle switching device, and the second electrically-controlled viewing angle switching device comprises a third substrate, a fourth substrate, a third alignment layer, a fourth alignment layer, and a second liquid crystal layer, wherein
the third substrate and the fourth substrate are stacked on each other,
the third alignment layer is disposed on the third substrate and has a third alignment direction,
the fourth alignment layer is disposed on the fourth substrate and has a fourth alignment direction, wherein the third alignment direction is perpendicular to the fourth alignment direction, and
the second liquid crystal layer is disposed between the third alignment layer and the fourth alignment layer, and
the third polarizer is disposed on one side of the second electrically-controlled viewing angle switching device facing away from the first electrically-controlled viewing angle switching device and has a third absorption axis, and the third absorption axis is parallel to or perpendicular to the fourth alignment direction.

6. The anti-peep module according to claim 5, wherein the first electrically-controlled viewing angle switching device has a double-sided anti-peep axial direction, the second electrically-controlled viewing angle switching device has a single-sided anti-peep direction, the single-sided anti-peep direction is parallel to the double-sided anti-peep axial direction, the first alignment direction is perpendicular to the double-sided anti-peep axial direction, and included angles between the third alignment direction and the fourth alignment direction and the single-sided anti-peep direction are in a range of 40 degrees to 50 degrees or 130 degrees to 140 degrees.

7. The anti-peep module according to claim 6, wherein the second absorption axis of the second polarizer is perpendicular to the third absorption axis of the third polarizer, and included angles between the second absorption axis and the third absorption axis and the single-sided anti-peep direction are in a range of 40 degrees to 50 degrees or 130 degrees to 140 degrees.

8. The anti-peep module according to claim 6, further comprising a half-wave plate, wherein
the half-wave plate is disposed between the first electrically-controlled viewing angle switching device and the second electrically-controlled viewing angle switching device, wherein when the absolute difference value between the first refractive index and the first extraordinary ray refractive index is less than 0.05, an included angle between a slow axis of the half-wave plate and the double-sided anti-peep axial direction is 110 degrees, and when the absolute difference value between the first refractive index and the first ordinary ray refractive index is less than 0.05, the included angle between the slow axis of the half-wave plate and the double-sided anti-peep axial direction is 65 degrees.

9. The anti-peep module according to claim 5, further comprising a first compensation film and a second compensation film, wherein
the first compensation film is disposed between the second polarizer and the second liquid crystal layer, and
the second compensation film is disposed between the third polarizer and the second liquid crystal layer, wherein an out-of-plane phase retardation of each of the first compensation film and the second compensation film is in a range of −50 nm to −300 nm.

10. The anti-peep module according to claim 1, wherein a difference value between the first extraordinary ray refractive index and the first ordinary ray refractive index is less than 0.12, and a height of each of the plurality of first spacers in a stacking direction of the first substrate and the second substrate is greater than 5 μm and less than 10 μm.

11. A display apparatus comprising a self-luminous display panel and an anti-peep module, wherein
the anti-peep module is disposed on one side of a display surface of the self-luminous display panel and comprises a first electrically-controlled viewing angle switching device, a first polarizer, and a second polarizer, wherein
the first electrically-controlled viewing angle switching device comprises a first substrate, a second substrate, a first alignment layer, a second alignment layer, a first liquid crystal layer, and a plurality of first spacers, wherein
the first substrate and the second substrate are stacked on each other,
the first alignment layer is disposed on the first substrate and has a first alignment direction,
the second alignment layer is disposed on the second substrate and has a second alignment direction, wherein an included angle between the first alignment direction and the second alignment direction is in a range of 165 degrees to 195 degrees,
the first liquid crystal layer is disposed between the first alignment layer and the second alignment layer and has a plurality of first liquid crystal molecules, each of the plurality of first liquid crystal molecules has a first optical axis, a first extraordinary ray refractive index, and a first ordinary ray refractive index, and the first extraordinary ray refractive index is greater than the first ordinary ray refractive index, and
the plurality of first spacers are disposed between the first substrate and the second substrate and each has a first refractive index, and the first refractive index is greater than the first ordinary ray refractive index and less than the first extraordinary ray refractive index,
the first polarizer is disposed on one side of the first liquid crystal layer where the first alignment layer is disposed and has a first absorption axis, and an axial direction of the first absorption axis is parallel to or perpendicular to the first alignment direction, and
the second polarizer is disposed on one side of the first liquid crystal layer where the second alignment layer is disposed and has a second absorption axis, and an axial direction of the second absorption axis is parallel to or perpendicular to the second alignment direction,
wherein when an absolute difference value between the first refractive index and the first extraordinary ray refractive index is less than 0.05, the axial direction of the first absorption axis is perpendicular to the first alignment direction, and when an absolute difference value between the first refractive index and the first ordinary ray refractive index is less than 0.05, the axial direction of the first absorption axis is parallel to the first alignment direction.

12. The display apparatus according to claim 11, wherein the first electrically-controlled viewing angle switching device further comprises a first electrode layer and a second electrode layer, wherein
the first electrode layer and the second electrode layer are respectively disposed on the first substrate and the second substrate and are configured to drive the plurality of first liquid crystal molecules of the first liquid crystal layer to rotate, and the display apparatus switches between a sharing mode and an anti-peep mode, when a first voltage is provided between the first electrode layer and the second electrode layer, the display apparatus operates in the anti-peep mode, when a second voltage is provided between the first electrode layer and the second electrode layer, the display apparatus operates in the sharing mode, and the second voltage is greater than the first voltage.

13. The display apparatus according to claim 11, further comprising a quarter-wave plate, wherein
the quarter-wave plate is disposed between the self-luminous display panel and the first polarizer, and an included angle between an optical axis of the quarter-wave plate and the first absorption axis of the first polarizer is 45 degrees.

14. The display apparatus according to claim 11, wherein the anti-peep module further comprises a second electrically-controlled viewing angle switching device and a third polarizer,
the second electrically-controlled viewing angle switching device is disposed on one side of the second polarizer facing away from the first electrically-controlled viewing angle switching device, and the second electrically-controlled viewing angle switching device comprises a third substrate, a fourth substrate, a third alignment layer, a fourth alignment layer, a second liquid crystal layer, and a plurality of second spacers, wherein
the third substrate and the fourth substrate are stacked on each other,
the third alignment layer is disposed on the third substrate and has a third alignment direction,
the fourth alignment layer is disposed on the fourth substrate and has a fourth alignment direction, wherein an included angle between the third alignment direction and the fourth alignment direction is in a range of 165 degrees to 195 degrees,
the second liquid crystal layer is disposed between the third alignment layer and the fourth alignment layer and has a plurality of second liquid crystal molecules, each of the plurality of second liquid crystal molecules has a second optical axis, a second extraordinary ray refractive index, and a second ordinary ray refractive index, and the second extraordinary ray refractive index is greater than the second ordinary ray refractive index, and
the plurality of second spacers are disposed between the third substrate and the fourth substrate and each has a second refractive index, and the second refractive index is greater than the second ordinary ray refractive index and less than the second extraordinary ray refractive index, and
the third polarizer is disposed on one side of the second electrically-controlled viewing angle switching device facing away from the first electrically-controlled viewing angle switching device and has a third absorption axis, and the third absorption axis is parallel to or perpendicular to the fourth alignment direction,
wherein when an absolute difference value between the second refractive index and the second extraordinary ray refractive index is less than 0.05, the axial direction of the second absorption axis is perpendicular to the third alignment direction, and when an absolute difference value between the second refractive index and the second ordinary ray refractive index is less than 0.05, the axial direction of the second absorption axis is parallel to the third alignment direction.

15. The display apparatus according to claim 11, wherein the anti-peep module further comprises a second electrically-controlled viewing angle switching device and a third polarizer,
the second electrically-controlled viewing angle switching device is disposed on one side of the second polarizer facing away from the first electrically-controlled viewing angle switching device, and the second electrically-controlled viewing angle switching device comprises a third substrate, a fourth substrate, a third alignment layer, a fourth alignment layer, and a second liquid crystal layer, wherein
the third substrate and the fourth substrate are stacked on each other,
the third alignment layer is disposed on the third substrate and has a third alignment direction,
the fourth alignment layer is disposed on the fourth substrate and has a fourth alignment direction, wherein the third alignment direction is perpendicular to the fourth alignment direction, and
the second liquid crystal layer is disposed between the third alignment layer and the fourth alignment layer, and
the third polarizer is disposed on one side of the second electrically-controlled viewing angle switching device facing away from the first electrically-controlled viewing angle switching device and has a third absorption axis, and the third absorption axis is parallel to or perpendicular to the fourth alignment direction.
